(19) United States
(12) Patent Application Publication
(10) Pub. No.: US 2011/0095863 A1
(43) Pub. Date: Apr. 28, 2011

(54) APPARATUS AND METHOD FOR A BIOMETRIC READER FOR ACCESS WITH IDENTIFICATION ON THE DEVICE

(76) Inventor: Mohamed LAAROUSSI, Orford (CA)

(21) Appl. No.: 12/903,343

(22) Filed: Oct. 13, 2010

Related U.S. Application Data
(60) Provisional application No. 61/255,105, filed on Oct. 27, 2009.

(51) Int. Cl. H04L 9/32; G06F 21/00; G06K 9/20; G06F 7/04

(52) U.S. Cl. 340/5.7; 726/19; 382/312

(57) ABSTRACT

A networkless biometric access device is provided hereby, the networkless biometric access device comprises a housing adapted to be secured in an electrical box, an electronic system comprising a biometric reader connected to the housing and adapted to scan fingerprints, and a memory module operatively connected to the biometric reader and adapted to store scanned fingerprints data therein. A method of using the networkless biometric access device and a kit comprising same is also provided hereby.

### CROSS-REFERENCE

The present invention claims priority from U.S. provisional patent application Ser. 61/255,105, filed on Oct. 27, 2009, entitled APPARATUS AND METHOD FOR A BIOMETRIC READER FOR ACCESS WITH IDENTIFICATION ON THE DEVICE, which is incorporated herein by reference.

### FIELD OF THE INVENTION

The present invention relates to biometric access reader adapted to provide selective access to a secured area. More precisely, the present invention relates to a networkless biometric access apparatus and a method of use thereof.

### BACKGROUND

Biometric readers for door or building access have been the subject of several patents for processes and equipment that use a fingerprint to grant access. In prior art, the devices and methods of biometric readers are generally very similar; the changes are minor because these devices rely on network databases for identification. However, we don't know of any device or process capable of controlling the identification parameters on the reader itself, or where the update is done using a remote medium and does not require a considerable level of expertise.

Fingerprint sensors and matching are reliable and are a widely used technique for personal identification or verification. In particular, a common approach to fingerprint identification involves analyzing a sample fingerprint or the fingerprint image and storing the image and/or the unique characteristics of the fingerprint image. The characteristics of a fingerprint sample can be compared to reference fingerprints already in a database to determine the correct identification of a person for verification purposes.

The fingerprint sensor is typically a sensor integrated circuit that controls the user's finger with electric field signals and the direction of the electric field with an array of electric fields sensing pixels on the circuit integrated substrate. These sensors are used to control the access to many types of different electronic devices such as computers, mobile phones, personal digital assistants (PDAs), etc. Specifically, fingerprint sensors are used because they have a small footprint, they are relatively easy to use, and they offer reasonable authentication capabilities.

Uchida's U.S. patent application published no. 2001/0025342 is oriented towards a method of biometric identification method and a system where the system includes a biometric input device and a biometric verifier provided separately. The biometric data input device has a biometric sensor and data encoder that encodes biometric data using secret information identifying the biometric data input device to forward the encoded data to the biometric verifier. The verifier decodes the encrypted biometric data using the secret information of the digital replication of the biometric data.

Some conventional security systems using digital fingerprints simply require an index to be returned indicating which model is a live sample. An application running on a server computer will then check the safety equipment of its own storage based on this response. A disadvantage of this approach is that an intruder could replace the software and hardware with a simple library with dynamic linking, for example, and a valid index is always returned regardless of which finger is presented. fact, no finger should be present at all. Therefore, even if the application and software cross-authenticate, there is still a unique easily identifiable attack point where malicious software can change the response to anything desired.

Other drawbacks of prior art devices and methods will become apparent to a skilled reader in light of the present application.

### SUMMARY

It is one aspect of the present invention to alleviate one or more of the drawbacks of the background art by addressing one or more of the existing needs in the art.

It is another object of the present invention to provide a biometric access device adapted to be installed without a network in standard electrical boxes to selectively grant access to an area or an object when a fingerprint associated with a fingerprint data stored in the access device is recognized.

One object of the present invention provides an access device equipped with a biometric reader that does not rely on an external network to grant access or not to a secured area or object.

Another object of the present invention provides an access device equipped with a biometric reader and an embedded memory adapted to receive fingerprint data.

One other object of the present invention provides an access device equipped with a biometric reader sized and designed to be installed in a standard electrical box normally used to receive an electric switch therein.

One object of the present invention provides an access device equipped with a biometric reader that can be integrated in an electrical switch and be installed in a standard electrical box.

Another object of the present invention provides an access device equipped with a biometric reader that is configured to selectively connects with a remote device to update instructions therein.

An aspect of the present invention provides an access device equipped with a biometric reader provided with a memory and microprocessor embedded therein.

One other aspect of the present invention provides an access device equipped with a biometric reader embedded in a standard electrical switch (interrupter).

One aspect of the present invention provides an electric switch incorporating an access device equipped with a biometric reader embedded and adapted to be secured in a standard electrical box.

Another aspect of the invention provides a access control device in which a biometric reader or device, having substantially the size and the format of an electrical switch, for controlling access is equipped with at least one slot in which to put a finger to scan the finger, at least one access module therein for fingerprint identification on the device itself and at least one medium receiving means (USB drive, smart card etc.) to update fingerprint stored in the access device; a finger is scanned for biometric reading; the biometric reader reads the fingerprint and identifies it directly on the control device without referring to an external database; and following identification of the fingerprint, the control device allows logical and/or physical access and gives the instruction to allow access to an external lock mechanism.

One other aspect of the present invention provides an access device, comprising a biometric reader, having the size and format of a light switch whose identification is done on the device itself and where the update is done using a removable medium requiring no authorizations from an external database.

Another aspect of the present invention provides an access device that complies with standards of personal data protection given there is no database that could link a person to a fingerprint.

An additional aspect of the present invention provides a method where an individual puts its finger on the device's scanner. Fingerprints are then analyzed by the device's processor, which accepts or denies access. The scanner reads information from the fingers and compares it with data recorded on the device itself.

One other aspect of the present invention provides an access device in which data is updated using an external medium (remote device); the data on the medium being adapted to be removed or added with an application on a computer.

One another aspect of the present invention provides an access device adapted to be powered with a low voltage source like a battery.

An aspect of the present invention provides an access device adapted to lock automatically after a predetermined period of time or that could remain unlocked until a finger is put another time on the securing device.

An aspect of the present invention provides a networkless biometric access device comprising a housing adapted to be secured in an electrical box, an electronic system comprising, a biometric reader connected to the housing and adapted to scan fingerprints, and a memory module operatively connected to the biometric reader and adapted to store scanned fingerprints data therein.

Another aspect of the present invention provides a method of using a networkless access device comprising reading a fingerprint with a scanner module embedded in the networkless access device comparing the scanned fingerprint with fingerprints stored in the memory module of the networkless access device, and actuating a mechanical lock control system if there is correlation between the scanned fingerprint and the fingerprints stored in the memory module of the networkless access device.

A networkless biometric access device kit comprising a networkless access device comprising a remote device connector thereon.

Additional and/or alternative advantages and salient features of the invention will become apparent from the following detailed description, which, taken in conjunction with the annexed drawings, disclose preferred embodiments of the invention.

### DESCRIPTION OF FIGURES(S)

FIG. 1 illustrates an illustrative perspective view of an access device in accordance with an embodiment of the present invention;

FIG. 2 illustrates an illustrative block diagram of an access device in accordance with an embodiment of the present invention;

FIG. 3 illustrates an illustrative flow chart diagram of a method of using an access device in accordance with an embodiment of the present invention;

FIG. 4 illustrates an illustrative flow chart diagram of a method of using an access device in accordance with an embodiment of the present invention; and

FIG. 5 illustrates an illustrative flow chart diagram of a method of using an access device in accordance with an embodiment of the present invention.

### DESCRIPTION OF EMBODIMENT(S)

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

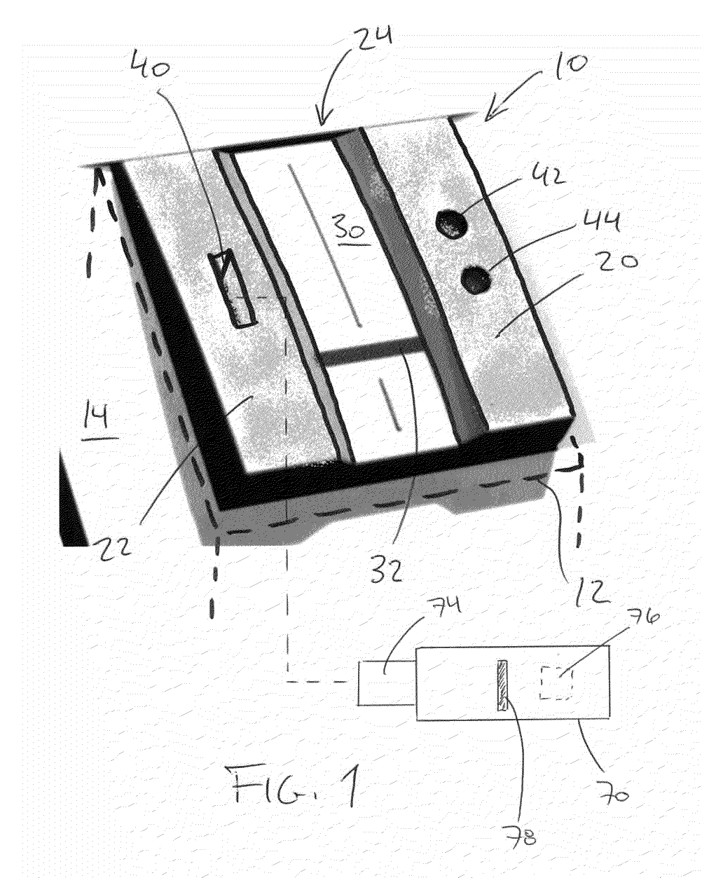

FIG. 1 illustrates an access device 10 adapted to be installed in an electrical box 12, perhaps in a wall 14. The electrical box 12 can be separated from the access device 10, or embedded therewith. The electrical box 12 of the present invention is a standard electrical box 12 and could come in various sizes despite a preferred embodiment relates to a light switch size receiving electrical box 12.

The access device 10 of the present invention is provided with two side portions 20, 22 and a biometric reader 30 disposed therein. The two side portions 20, 22 form a recess portion 24 therebetween adapted to help a user to position its finger on the biometric reader 30 by sensing the recess portion 24 with his/her finger. It can be appreciated that the biometric reader 30 is provided with a sensor area 32 from which the fingerprint of a user is scanned with a swiping motion thereon. Other alternate fingerprint sensors/scanners 32 commercially available could replace/alter the illustrated sensor area 32 without departing from the scope of the present invention.

Still in FIG. 1, the side portions 20, 22 provide a remote device connector 40 and a plurality of visual indicators 42, 44 as a user interface. The remote device connector 40 is adapted to receive and operatively connects with a remote device 70 (not shown on FIG. 1) configured to carry and transmit data to and/or from the access device 10. The remote device could be embodied as a USB key, a memory stick, an RFID device or another medium suitable to carry instructions therein. Visual indicators 42, 44 are embodied as LEDs in the present embodiment and provide information to a user by changing colors or states (on/off/blinking).

The access device 10 of the present embodiment is self contained in a plastic casing and ready to be installed in a standard electrical box 12 as typically illustrated at

http://www.tnbcanada.com/en/catalogues/online/comresconstruction/pdf/c1/boxe s_{—}20_eng.pdf

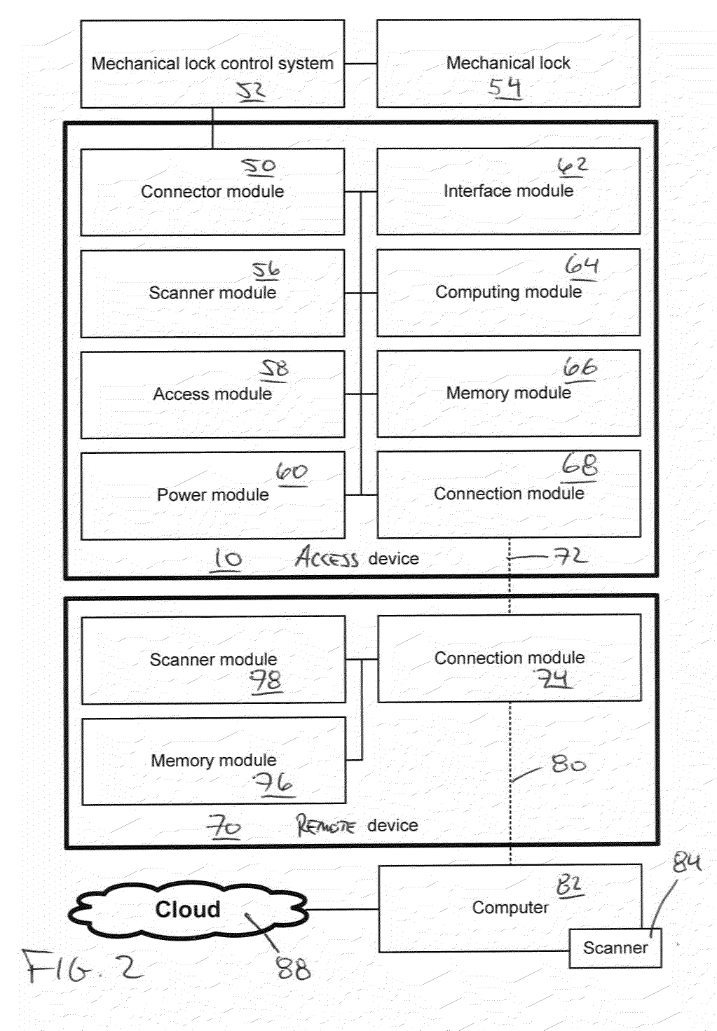

Turning now to FIG. 2 illustrating a block diagram of the system. The access device 10 comprises a plurality of modules cooperating together to provide the functions carried out by the access device 10. A connector module 50 is adapted to interface with an external lock control system 52 that is operatively connected to a mechanical lock 54. Signals from the access device 10 through the connector module 50 will selectively actuate the mechanical lock 54 when required.

A scanned module 56 is provided in the access device 10 to scan fingerprints. The scanner module 56 interacts with the biometric reader 30 through sensor area 32. An access module 58 manages the instructions and the data to give access or not to a user based on the scanned fingerprint. A power module 60 is provided to power the access device 10 with all its modules. The power module 60 is configured to draw power either from the grid or from a battery included in the access device 10. The power module 60 transforms the current in a form compatible with the current required by the access device 10. The interface module 62 manages the signals provided to a user via visual indicators 42, 44. LEDs are selectively powered in accordance with functions and instructions of the access device 10 to provide simple comprehensive information to the user. A computing module 64 is provided in the access device 10 to compute instructions and data in accordance with the functions carried out by the access device 10. The memory module 66 is adapted to store fingerprint data and instructions therein for the other modules' needs. A connection module 68 is also provided in the access device to connect with an external medium. The connection module 68 is operatively connected with the remote device connector 40.

Still in FIG. 2, the remote device 70 illustrated herein is selectively connected 72 to the access device 10 via its own connection module 74. One significant role of the remote device 70 is to carry data and instructions to and from the access device and is provided with an embedded memory module 76. An optional scanner module 78 is illustratively provided to scan fingerprints and directly store data in the remote device 70 without recourse to the access device. The optional scanner module 78 is completed with proper biometric reader (not illustrated in FIG. 2) therewith physically embedded in the remote device 70.

The connection module 74 of the remote device 70 can be selectively connected 80 to a computer 82 to manage instructions therein. The computer 82 can have its own fingerprint scanner 84 to scan fingerprints remotely from the access device 10. The computer 82 is connected to the cloud 88 and the Internet. This offers several additional possibilities like managing the access code device 10 instructions via a web-based application.

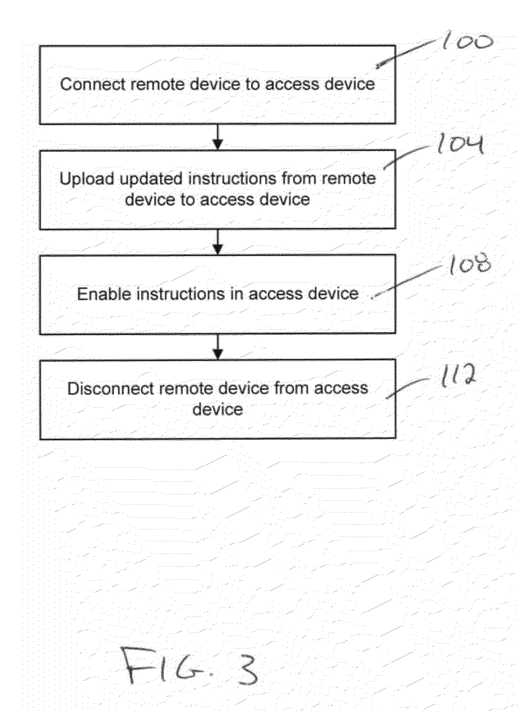

Moving now to FIG. 3 illustrating a process consisting of connecting 100 a pre-loaded remote device 70 to the access device 10. Once the connection is established, the instructions and data from the remote device 70 are transferred 104 to the access device 70. The newly transferred instructions are enabled 108 in the access device 10 and the remote device 70 can be disconnected 112 from the access device 10.

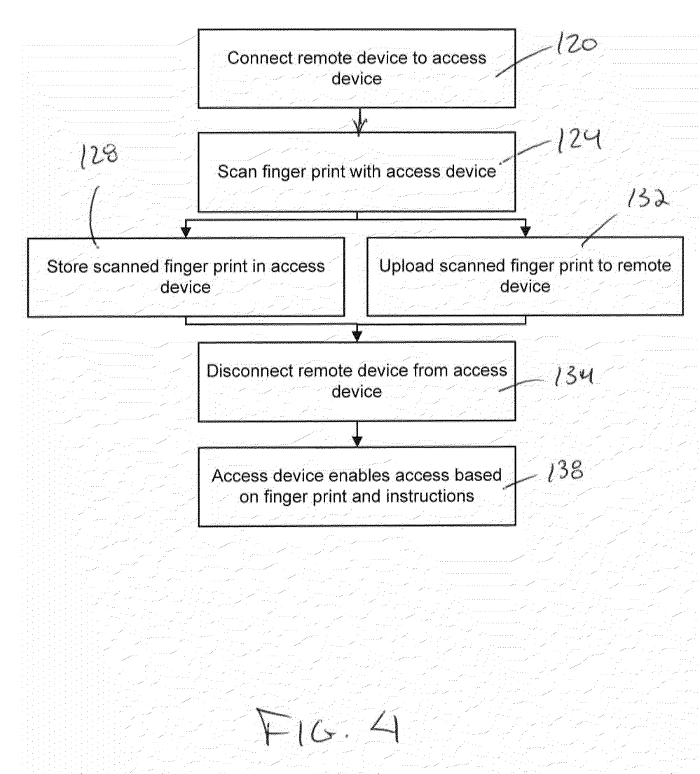

FIG. 4 illustrates another exemplary process using the remote device 70 and the access device 10. The remote device 70 is connected 120 to the access device 10 and fingerprints are scanned 124 with the access device 10. The scanned fingerprints are then stored 128 in the access device 10 memory module 66 and/or uploaded 132 in the memory module 76 of the remote device 70 for use, inter alia, on the computer 82. The remote device 70 is disconnected 134 from the access device 10 and the access device 10 begins to enables access 138 based on the newly scanned fingerprint.

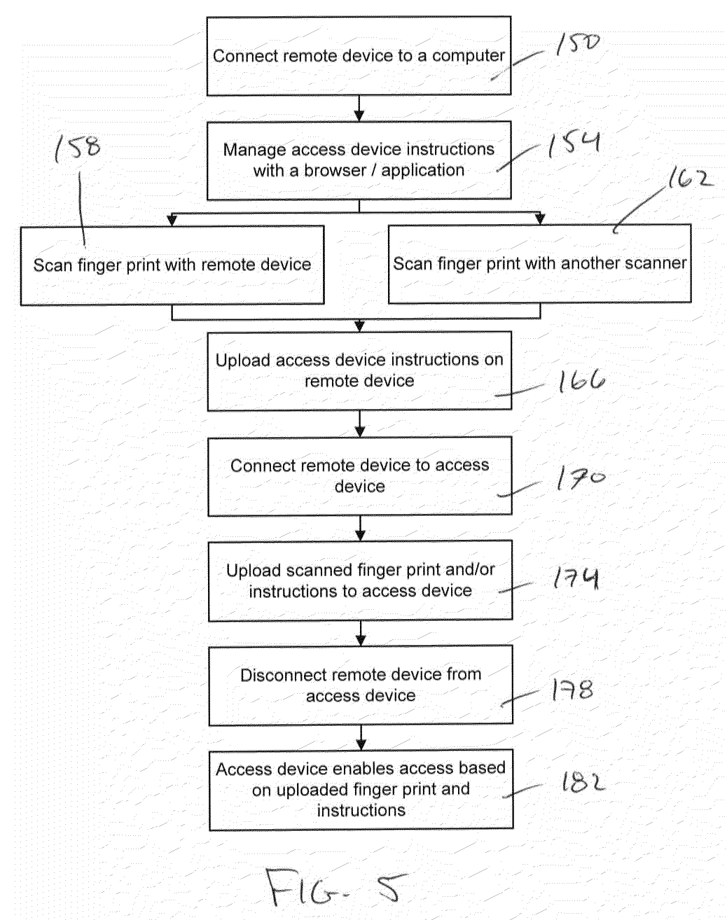

Turning now to FIG. 5 showing a flow chart of steps illustrating an alternate process carried out by the present invention. The remote device 70 is connected 150 to the computer 82 and the instructions and data therein is managed with either an application installed on the computer or a web-based application 154. Fingerprints are either scanned 158 with the remote device 70 or with another scanner 162 connected to the computer 82. Instructions are uploaded 166 from the computer 82 to the remote device 70 to be transferred to the access device 10 upon connection 170 therewith. The scanned fingerprint are also uploaded 174 to the access device 10 before the remote device 70 is disconnected 178 from the access device 178 to finally allow the access device 10 to determine access right 182 of users based on their scanned fingerprint.

The description and the drawings that are presented above are meant to be illustrative of the present invention. They are not meant to be limiting of the scope of the present invention. Modifications to the embodiments described may be made without departing from the present invention, the scope of which is defined by the following claims :

What is claimed is:

1. A networkless biometric access device comprising:
a housing adapted to be secured in an electrical box;
an electronic system comprising
a biometric reader connected to the housing and adapted to scan fingerprints; and
a memory module operatively connected to the biometric reader and adapted to store scanned fingerprints data therein.

2. The networkless biometric access device of claim 1, wherein the biometric access device further comprises a remote device connector adapted to operatively connect with a remote device to exchange data and instructions to and from the access device.

3. The networkless biometric access device of claim 2, wherein the remote device connector is a USB connector.

4. The networkless biometric access device of claim 3, wherein the remote device connector is adapted to receive a chip-equipped card.

5. The networkless biometric access device of claim 1, wherein the access device relies only on fingerprint data stored therein to grant access or not.

6. The networkless biometric access device of claim 1, wherein the access device further comprises a connector module adapted to transmit a lock actuation signal upon scanning and approval of a scanned fingerprint on the biometric reader.

7. The networkless biometric access device of claim 6, wherein the lock actuation signal is granted upon recognition of a compatible reference fingerprint stored in the memory module.

8. The networkless biometric access device of claim 1, wherein the remote device uses the same a connector to operatively connect with the remote device connector and to a computer.

9. The networkless biometric access device of claim 1, wherein the remote device comprises a scanner module.

10. The networkless biometric access device of claim 1, wherein a battery powers the networkless biometric access device.

11. A method of using a networkless access device comprising:
reading a fingerprint with a scanner module embedded in the networkless access device;
comparing the scanned fingerprint with fingerprints stored in the memory module of the networkless access device; and
actuating a mechanical lock control system if there is correlation between the scanned fingerprint and the fingerprints stored in the memory module of the networkless access device.

12. The method of using a networkless access device of claim 11, comprising:
connecting a remote device on the access device;
transferring instructions to the access device; and
removing the remote device from the access device to enable instructions in the access device.

13. The method of claim 12, comprising:
connecting the remote device on a computer; and
manipulating instructions therein with the computer.

14. The method of claim 13, comprising:
scanning a fingerprint with the remote device.

15. The method of claim 14, comprising:
downloading the scanned fingerprint in the access device.

16. The method of claim 12, comprising:
accessing stored information in the remote device with an Internet browser.

17. A networkless biometric access device kit comprising:
a networkless access device comprising a remote device connector thereon.

18. The networkless biometric access device kit of claim 17 further comprising a remote device adapted to carry instructions therein and adapted to be operatively connectable to the remote device connector to exchange data with the access device.

19. The networkless biometric access device kit of claim 18, wherein the networkless access device is a plurality of networkless access devices.
